(19) United States
(12) Patent Application Publication
(10) Pub. No.: US 2014/0144152 A1
(43) Pub. Date: May 29, 2014

(54) Premixer With Fuel Tubes Having Chevron Outlets

(71) Applicant: GENERAL ELECTRIC COMPANY, Schenectady, NY (US)

(72) Inventors: Jong Ho Uhm, Simpsonville, SC (US); Thomas Edward Johnson, Greer, SC (US); Baifang Zuo, Simpsonville, SC (US); Christian Xavier Stevenson, Inman, SC (US)

(73) Assignee: GENERAL ELECTRIC COMPANY, Schenectady, NY (US)

(21) Appl. No.: 13/684,891

(22) Filed: Nov. 26, 2012

(51) Int. Cl. F02C 7/22

(52) U.S. Cl. CPC F02C 7/22
USPC 60/776; 60/737; 60/738

(57) ABSTRACT

A premixer includes an air tube formed in a burner tube defining a longitudinal axis, and a coaxially disposed fuel tube with a turbulence enhancing chevron outlet. The fuel tube may include an exterior tube and an interior tube with the interior tube, the exterior tube or both having chevron outlets. The chevron outlets may be tapered and notched.

### CROSS-REFERENCE TO RELATED APPLICATIONS

This application is related to co-pending U.S. patent applications entitled “PREMIXER WITH DILUENT FLUID AND FUEL TUBES HAVING CHEVRON OUTLETS”, Ser. No. ______, filed concurrently herewith.

### GOVERNMENT RIGHTS

This invention was made with Government support under contract number DE-FC26-05NT42643 awarded by the Department of Energy. The Government has certain rights in this invention.

### TECHNICAL FIELD

The subject matter disclosed herein relates to premixing devices for injection nozzles and more particularly to a premixer having coaxial fuel tube for enhanced mixing, flame holding and flashback resistance.

### BACKGROUND

Gas turbine manufacturers are continuously improving the emission performance of gas turbines. The primary pollutant produced by gas turbines are oxides of nitrogen (NOx), carbon monoxide (CO) and unburned hydrocarbons. NOx emissions depend upon the maximum temperature in the combustor and the residence time for the reactants. One known method of controlling the temperature in the combustor is to premix fuel and air to a lean mixture prior to combustion. Such premixing tends to reduce combustion temperatures and undesirable NOx emissions. In these systems fuel is mixed with air using a premixing device that is upstream of a combustion zone for creating a premixed flame at lean conditions to reduce emissions from the combustor. Ideally, the flame should be contained inside of the combustor downstream of the fuel/air premixing passages. However, premixing devices are susceptible to flashback. During flashback, the fuel and air mixture in the premixing passages combusts. The flashback condition generally occurs when a flame travels upstream from the main burning zone into the premixing zone. Serious damage may occur to the combustion system when flame holding or flashback occurs. Similarly, the flame may develop on or near surfaces, which can also result in damage due to the heat of combustion. This phenomenon is generally referred to as flame holding. For example, the flame holding may occur on or near a fuel nozzle in a low velocity region. In particular, an injection of a fuel flow into an air flow may cause a low velocity region near the injection point of the fuel flow, which can lead to flame holding.

Typically, it is difficult to control flame holding in premixing devices. In some combustors, the average velocity of fuel/air mixture may be increased within a mixing region of the premixing device for enhancing the flame holding margins in such devices. However, this results in a relatively high pressure drop across the combustor, thereby decreasing the combustor efficiency.

### BRIEF DESCRIPTION OF THE INVENTION

In accordance with one exemplary non-limiting embodiment, the invention relates to a premixer having a fuel plenum, a burner tube, and an air tube formed in the burner tube. A fuel tube having a chevron outlet is coaxially disposed inside the air tube. An air source is coupled to the air tube. The premixer includes a bell mouth disposed at least partially about the burner tube and coupled to the air source, the bell mouth adapted to direct air into the air tube.

In another embodiment, the invention relates to a combustor with a fuel source, an air source, and a premixer. The premixer includes a burner tube and an air tube formed in the burner tube and coupled to the air source, and a fuel tube with a turbulence enhancing chevron outlet disposed inside the air tube and coupled to the fuel source. The premixer also includes a bell mouth disposed at least partially about the fuel tube and coupled to the air source the bell mouth adapted to direct air into the at least one air tube.

In another embodiment, an apparatus is provided that includes a fuel source, a first fuel tube coupled to the fuel source and a chevron outlet for enhancing turbulence of fuel flowing through the first fuel tube. The apparatus also includes an air tube surrounding the first fuel tube an air source, and an air directing component coupled to the air source and adapted to direct air into the air tube.

### BRIEF DESCRIPTION OF THE DRAWINGS

Other features and advantages of the present invention will be apparent from the following more detailed description of the preferred embodiment, taken in conjunction with the accompanying drawings which illustrate, by way of example, the principles of certain aspects of the invention.

FIG. 1 is a perspective view of an embodiment of a premixer.

FIG. 2 is a cross-sectional view of an embodiment of a premixer.

FIG. 3 is a cross-sectional view of an embodiment of a premixer.

FIG. 4 is a perspective view of an embodiment of a fuel tube.

FIG. 5 is a cross-sectional view of an embodiment of a fuel tube.

FIG. 6 is a cross-sectional view of an embodiment of a fuel tube.

FIG. 7 is a cross-sectional view of an embodiment of a fuel tube.

FIG. 8 is a perspective view of an embodiment of a fuel tube.

FIG. 9 is a cross-sectional view of an embodiment of a fuel tube.

FIG. 10 is a perspective view of an embodiment of a fuel tube.

FIG. 11 is a cross-sectional view of an embodiment of a fuel tube.

FIG. 12 a perspective view of an alternate embodiment of a premixer.

FIG. 13 is a cross-sectional view of an embodiment of a premixer.

FIG. 14 is a cross-sectional view of an embodiment of a fuel tube.

FIG. 15 is a cross-sectional view of an embodiment of a fuel tube.

FIG. 16 is a cross-sectional view of an embodiment of a fuel tube.

FIG. 17 is a cross-sectional view of an embodiment of a fuel tube.

FIG. 18 is a cross-sectional view of an embodiment of a fuel tube.

FIG. 19 is a cross-sectional view of an embodiment of a fuel tube.

FIG. 20 is a cross-sectional view of an embodiment of a nozzle assembly.

FIG. 21 is a cross-sectional view of an embodiment of a nozzle assembly.

FIG. 22 is a schematic of an embodiment of a turbine system with a nozzle assembly.

### DETAILED DESCRIPTION OF THE INVENTION

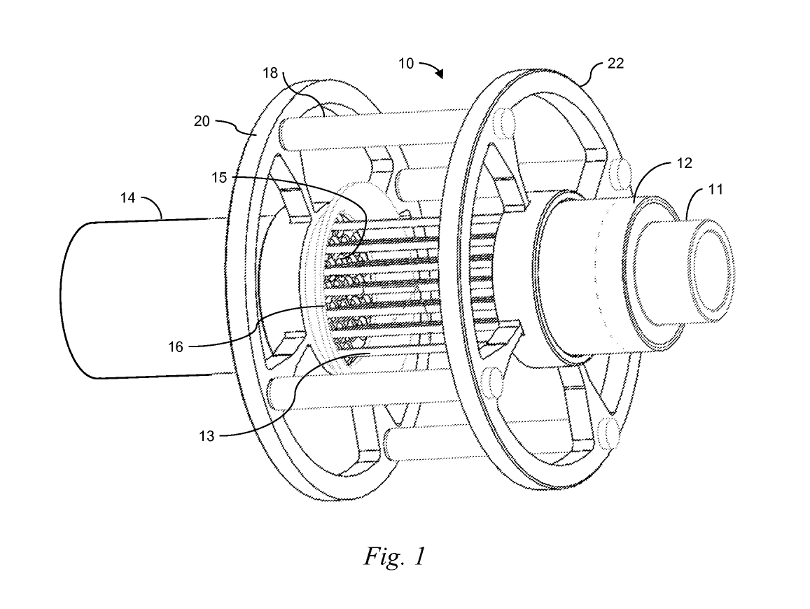

FIG. 1 shows a premixer 10 as may be described herein. The premixer 10 may be used in a combustor (not shown) and in similar devices. The premixer 10 may include a fuel conduit 11 coupled to a fuel plenum 12. The fuel plenum 12 is in fluid communication with one or more fuel tubes 13. The fuel plenum 12 may have any desired size or configuration. Any number of fuel tubes 13 may be used herein. The fuel tubes 13 may have any desired size or configuration.

The premixer 10 also may include a burner tube 14. The burner tube 14 may include one or more air tubes 15 extending through the burner tube 14. Any number of the air tubes 15 may be used. The air tubes 15 may have any desired size or configuration. The air tubes 15 may extend from a bell mouth 16 facing the fuel plenum 12 to an opposite burner tube 14. The air tubes 15 may have a larger diameter as compared to the fuel tubes 13.

The fuel plenum 12 and the burner tube 14 may be separated by a number of spacers 18. Any number of spacers 18 may be used. The spacers 18 may have any desired size or configuration. The spacers 18 may be attached to a burner tube flange 20 on one end and a fuel plenum flange 22 on the other. The fuel plenum flange 22 and the burner tube flange 20 may have any desired size or configuration. Other types of connection means may be used herein. The spacing between the fuel plenum 12 and the burner tube 14 may vary.

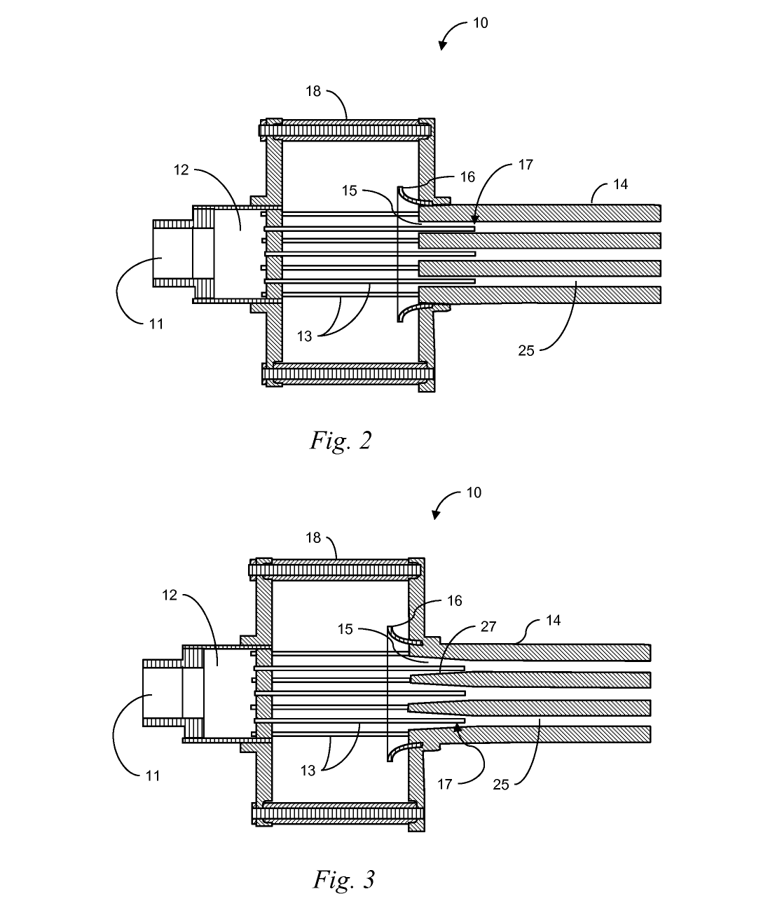

A number of the fuel tubes 13 may extend from the fuel plenum 12 into a number of the air tubes 15 within the burner tube 14. The fuel tubes 13 have a downstream end portion 17 (shown in FIG. 2) that may be provided with a variety of geometries. Fuel thus may enter the fuel plenum 12 via fuel conduit 11 and may be distributed to the fuel tubes 13. The fuel may then be injected from the downstream end portion 17 (shown in FIG. 2) of the fuel tube 13 into an air stream in each of the air tubes 15 so as to mix the fuel and air. Likewise, the air flow may be guided between the fuel plenum 12 and the bell mouth 16 and into the air tubes 15. Some or all of the air tubes 15 may have one of the fuel tubes 13 positioned therein. The premixer 10 thus may use a plurality of air tubes 15 with a plurality of fuel tubes 13 so as to create multiple co-flow jets of air and fuel. As used herein, the term “co-flow” means the fuel and air flow in the same direction at the point of injection of the fuel. The size and number of the fuel tubes 13, and air tubes 15 may vary. Other configurations of the premixer 10 may be used herein.

Illustrated in FIG. 2 is an embodiment of a premixer 10 having a fuel conduit 11, a fuel plenum 12, and a plurality of fuel tubes 13 coupled to the fuel plenum 12. A plurality of air tubes 15 are formed in the burner tube 14. A bell mouth 16 is disposed around the burner tube 14 and functions to force air into the plurality of air tubes 15. One of the plurality of fuel tubes 13 may be disposed coaxially within one of the plurality of air tubes 15 which feed fuel and air into a mixing portion 25 of air tubes 15 wherein the air and fuel are mixed. As used herein, the terms “coaxial” and “coaxially” means that the fuel tubes 13 and the air tubes 15 substantially share a common longitudinal axis or have longitudinal axes that are substantially parallel to each other. The terms “coaxial” and “coaxially” are intended to be interpreted broadly and include small variations in the angles formed by the respective longitudinal axes of the air tubes 15 and the fuel tubes 13 and minor offsets between the longitudinal axes. The arrangement of the fuel tubes 13 and the air tubes 15 enable the creation of a flow jet of air and fuel within the mixing portion 25. Multiple flow jets of air and fuel may be obtained using multiple pairs of fuel tubes 13 and air tubes 15.

Illustrated in FIG. 3 is an embodiment of a premixer 10 wherein the air tubes 15 are provided with a tapered upstream section 27. The term “tapered”, as used herein means a structure that is not uniform in dimension. For example, the tapered upstream section 27 of one of the air tubes 15 may have a larger diameter than the diameter of the downstream section of the air tubes 15. This configuration helps to accelerate the airflow for better fuel and air mixing in the mixing portion 25 of the air tubes 15 and to obtain an enhanced margin of flashback/flame holding and faster fuel/air mixing that can shorten the length of the body of the air tubes 15 and result in reduced NOx.

In operation, fuel enters the fuel plenum 12, and is conveyed into the fuel tubes 13. Air is entrained by bell mouth 16 and is conveyed to the air tubes 15. The fuel and air mix in the mixing portion 25 of the air tubes 15. The fuel exiting the fuel tubes 13 is provided with enhanced turbulence resulting from the various chevron configurations of the downstream end portion 17 of the fuel tubes 13 (described in detail below) thereby shortening the length required to achieve adequate mixing in the mixing portion 25 of the air tubes 15.

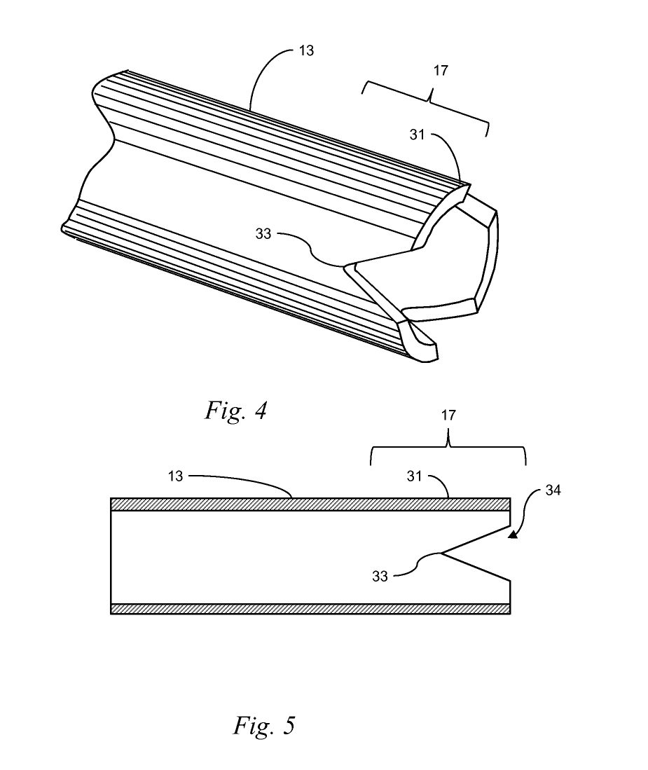

FIGS. 4 and 5 illustrate the downstream end portion 17 of one of the fuel tubes 13. As used herein, the term “downstream” means in the direction of flow of the fuel/air mixture. The fuel tubes 13 may have a cylindrical end 31 that is provided with a V-shaped notch 33. The V-shaped notch 33 induces and enhances the turbulence of the fuel/air flow beyond the downstream end portion 17 of the fuel tubes 13 to enable the mixing of fuel and air in the mixing portion 25 of the air tubes 15 within a shorter interval and shorter length along the air tubes 15. The V-shaped notch 33 defines a turbulence enhancing chevron outlet 34 that increases the turbulence intensity of the fuel/air mixture and widens the mixing layer beyond the point of the fuel injection. The configuration of the downstream end portion 17 of the fuel tubes 13 may vary as shown from the following examples.

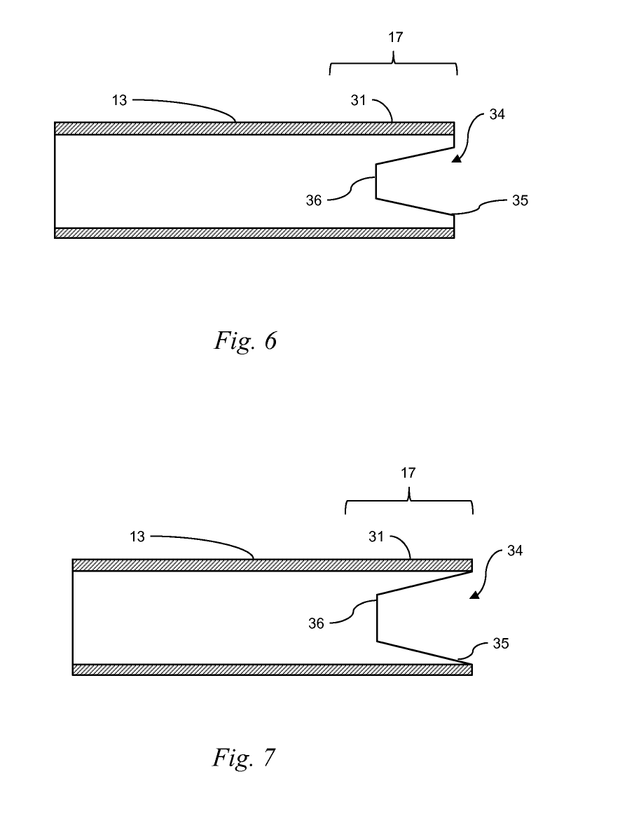

FIGS. 6 and 7 illustrate alternate embodiments of the downstream end portion 17 of one of the fuel tubes 13. In both embodiments, a straight notch 35 with a straight inboard portion 36 is provided. The circumferential dimensions of the straight notch 35 may vary as shown.

It should be noted that the illustrated embodiments of the turbulence enhancing chevron outlet 34 represent general examples and are not intended to be limiting. For example, other shapes of a turbulence enhancing chevron outlet 34 may be used. Similarly the dimensions of the turbulence enhancing chevron outlet 34 may be varied without departing from the spirit and scope of the invention as described and claimed herein. Other geometries and means for enhancing the turbulence of the fuel exiting the fuel tube 13 may be used as may be apparent to one of ordinary skill in the art in light of the teachings herein.

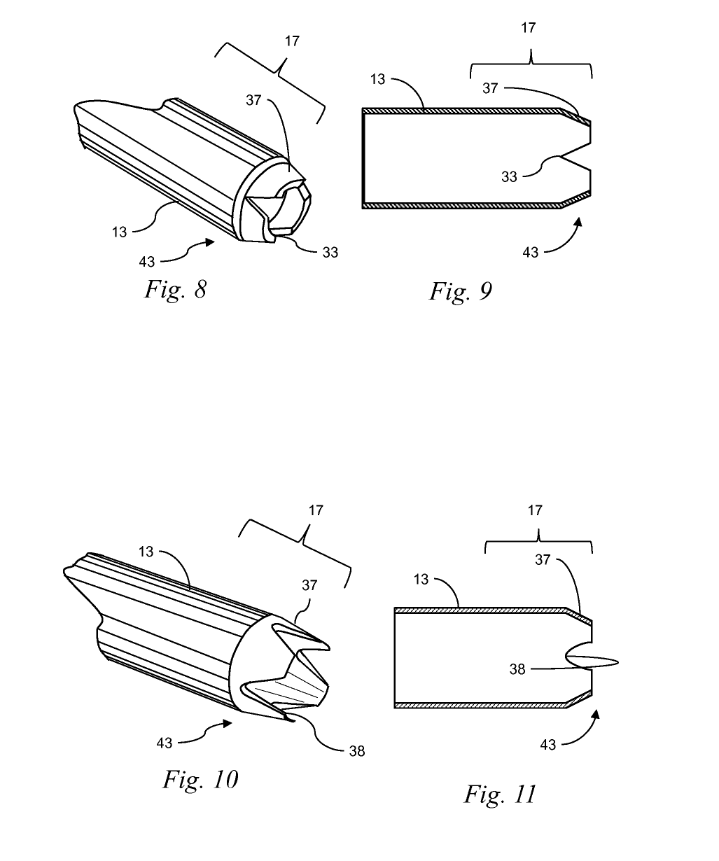

FIGS. 8 and 9 illustrate the downstream end portion 17 of one of the fuel tubes 13 that is provided with a downstream end 43 that is tapered (tapered end 37). The tapered end 37 may be provided with a V-shaped notch 33.

FIGS. 10 and 11 illustrate the downstream end of one of the fuel tubes 13 that is provided with a tapered end 37 and with a U-shaped notch 38.

As one of ordinary skill in the art will appreciate, different numbers and shapes of notches (chevrons) and different angles and lengths of taper for the downstream end portion 17 of fuel tubes 13 may be selectively applied to form other possible embodiments of the present invention.

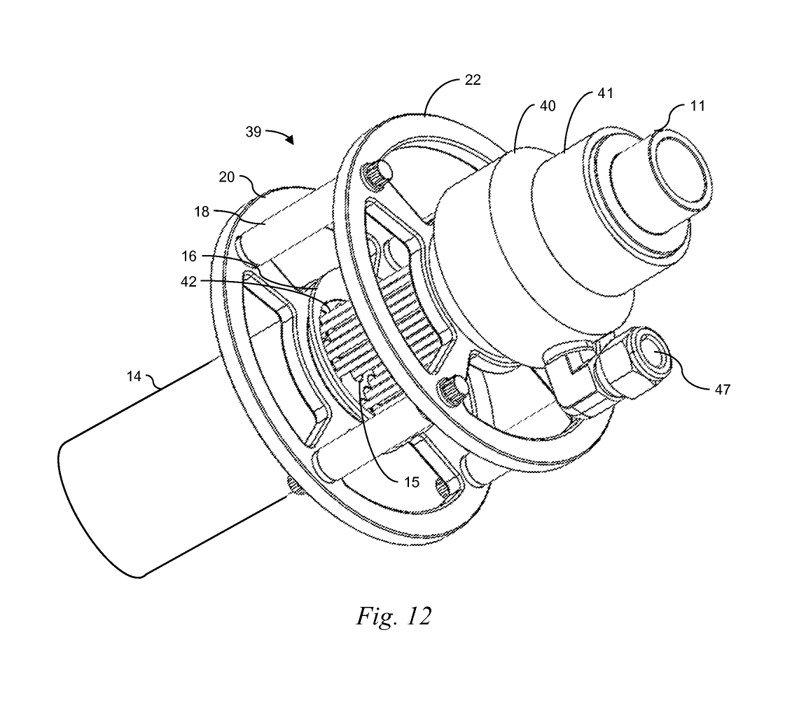

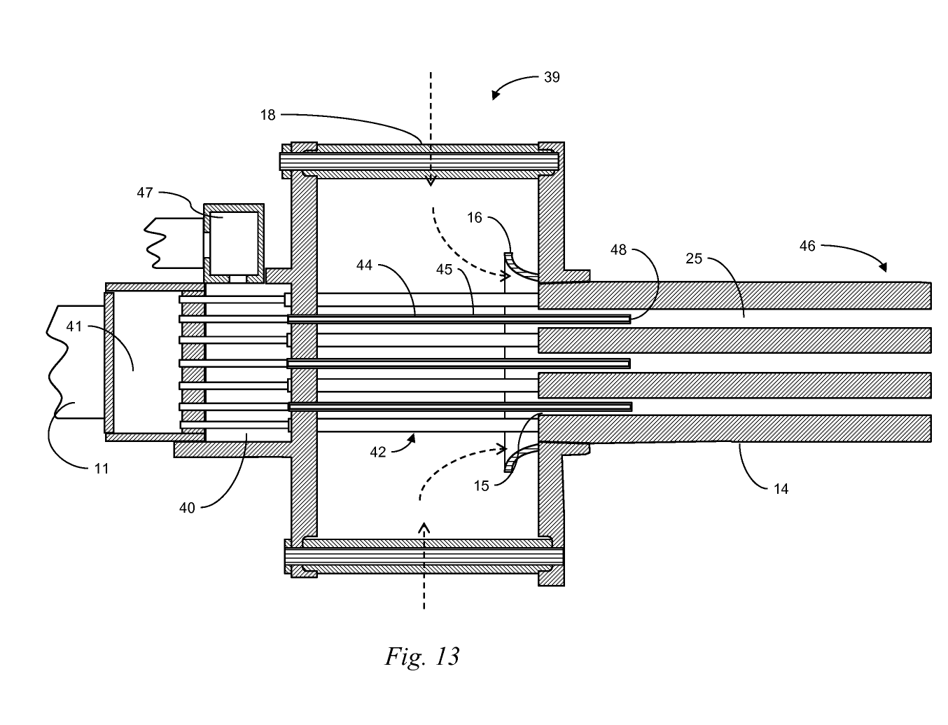

FIGS. 12 and 13 show an alternative embodiment of a premixer 39 as is described herein. In this embodiment, the premixer 39 includes a downstream plenum 40 and an upstream plenum 41. The downstream plenum 40 and the upstream plenum 41 may have any desired size or configuration. In one embodiment, the upstream plenum 41 is used as a plenum for fuel and the downstream plenum 40 is used as a plenum for diluent. The premixer 39 includes one or more coaxial tube assemblies 42. Each of the one or more coaxial tube assemblies 42 includes an interior tube 44 (shown in FIG. 13) that may extend from the upstream plenum 41 and pass through the downstream plenum 40. Likewise, an exterior tube 45 may extend from the downstream plenum 40. The exterior tube 45 may surround the interior tube 44. The size and number of coaxial tube assemblies 42 may vary. Other configurations may be used herein.

The premixer 39 also includes a burner tube 14 coupled to a combustion chamber (not shown). As above, the burner tube 14 includes a number of air tubes 15 extending through the burner tube 14. The size and number of the air tubes 15 may vary. The air tubes 15 may extend from the bell mouth 16 to a downstream end 46 of burner tube 14. Some of the air tubes 15 may have interior tube 44 extending therein while others may have exterior tube 45 extending therein. The air tubes 15 may have a larger diameter as compared to the coaxial tube assemblies 42.

The premixer 39 also may include a number of spacers 18 that separate the downstream plenum 40 and the burner tube 14. Any number of spacers 18 may be used. The spacers 18 may have any desired size or configuration. The downstream plenum 40 may have a fuel plenum flange 22 while the burner tube 14 may have a burner tube flange 20. Fuel plenum flange 22 and burner tube flange 20 may have any desired size or configuration. Other types of connection means may be used herein. The spacing between the downstream plenum 40 and the burner tube 14 may vary.

Fuel or other types of flows thus may flow from the upstream plenum 41 and the downstream plenum 40 through the coaxial tube assemblies 42, and mix with the air in the air tubes 15. The upstream plenum 41 and downstream plenum 40 may be used with different arrangements of fuel, air, and diluents. For example, the downstream plenum 40 may be used with a diluent such as nitrogen (N₂) while the upstream plenum 41 may be used with a fuel such as hydrogen (H₂), or methane CH₄), or a combination of both. Alternatively, the diluent flow may be or include a less reactive fuel. This arrangement of diluent and fuel may create a diluent inert sheath surrounding the flow of fuel. Such a diluent inert sheath passing through the air tubes 15 may prevent flame holding inside air tubes 15.

Other fuel and air mixing mechanisms may be used herein. For example, the upstream plenum 41 may be arranged with air while the downstream plenum 40 may have a mixture of hydrogen and nitrogen. Likewise, the upstream plenum 41 may use nitrogen while the downstream plenum 40 may use combinations of hydrogen and nitrogen. Other arrangements and different types and combinations of air, fuel, and diluent may be used herein.

The premixer 10, and premixer 39 described herein (in FIGS. 2 and 13 respectively) thus may use multiple fuel and air tubes 15 to create multiple co-flow jets of air and fuel. Fuel and air mixing may be enhanced due to the length versus the diameter of the air tubes 15. The premixer 10 and the premixer 39 also may use jets of fuel in combination with a sheath of diluent and/or diluent and air. The multiple jets also provide an increased flame holding margin due to the increased axial component of the fuel flow to air flow and by compartmentalizing the conventional burner tube into the multiple tubes. Local quenching also may be induced by the inert nitrogen, other diluents, and/or a high flow of air so as to limit flame holding. Very low emissions thus may be achieved by the good mixing caused by injecting the fuel into each air tube 15.

Illustrated in FIG. 13 is a cross-section of premixer 39. As with the previous embodiment discussed with regard to FIG. 1, the premixer 39 includes an upstream plenum 41 and a downstream plenum 40 with associated fuel conduits 11 and diluent fluid conduits 47, respectively. The premixer 39 may include one or more coaxial tube assemblies 42 having an interior tube 44 and an exterior tube 45. In one embodiment, the interior tube 44 may be coupled to the upstream plenum 41. Bell mouth 16 forces air into a plurality of air tubes 15. The interior tube 44 and exterior tube 45 are disposed coaxially within air tubes 15. The air and fuel are mixed in mixing portion 25 of the air tubes 15. In one embodiment, the exterior tube 45 may be coupled to downstream plenum 40 which is in turn coupled to the diluent fluid conduit 47 that provides diluent fluid such as air or an inert fluid such as N₂. In another embodiment, the interior tube 44 may be coupled to the downstream plenum 40 as a plenum for diluent fluid and the exterior tube 45 may be coupled to the upstream plenum 41 as a plenum for fuel.

In the premixer 39 illustrated in FIG. 13, fuel enters the upstream plenum 41 through the fuel conduit 11. A diluent fluid is provided to the downstream plenum 40 through the diluent fluid conduit 47. The interior tube 44 of the coaxial tube assemblies 42 may be coupled to the upstream plenum 41, and the exterior tube 45 may be coupled to the downstream plenum 40. The fuel and diluent fluid exiting the coaxial tube assemblies 42 may be provided with enhanced turbulence resulting from the various configurations of the downstream end 48 of the coaxial tube assemblies 42, thereby shortening the length of air tubes 15 required to achieve adequate mixing. As one of ordinary skill in the art will appreciate, the fuel may also be transported through exterior tube 45, and the diluent fluid may be transported through the interior tube 44.

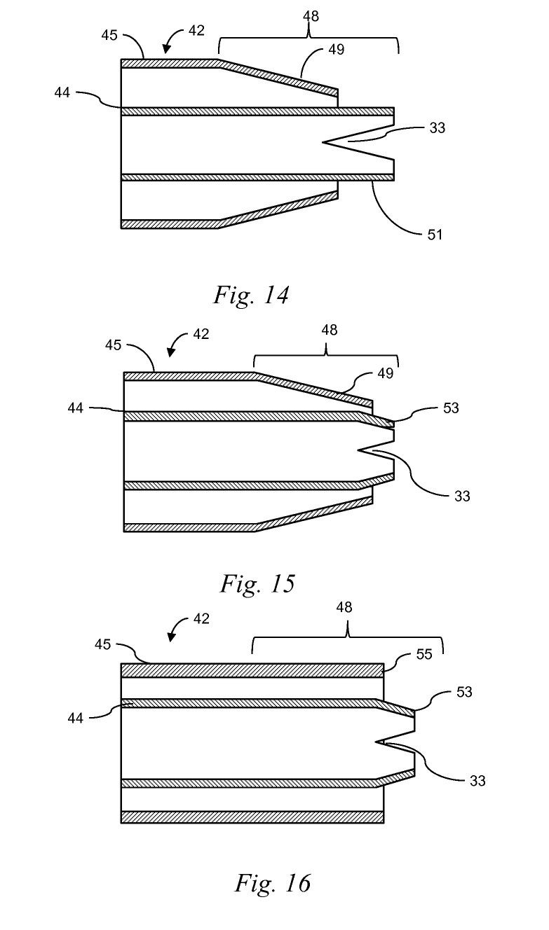

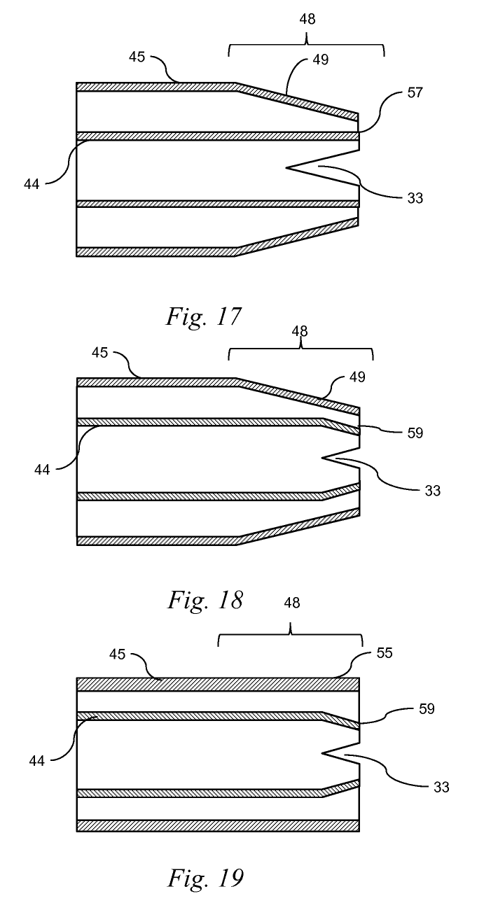

The downstream end 48 of the coaxial tube assemblies 42 may have one of a variety of configurations as illustrated in FIGS. 14-19. FIG. 14 illustrates an embodiment of one of the coaxial tube assemblies 42 where the downstream end 48 of the exterior tube 45 has a tapered end 49, and the interior tube 44 has a protruding straight end 51 with a V-shaped notch 33. FIG. 15 illustrates an embodiment where the downstream end 48 of the exterior tube 45 has a tapered end 49, and the interior tube 44 also has a tapered end 53. FIG. 16 illustrates an embodiment where the downstream end 48 of the exterior tube 45 has a straight end 55, and the interior tube 44 has a tapered end 53 that protrudes from the downstream end 48 of the exterior tube 45. FIG. 17 illustrates an embodiment where the downstream end 48 of the exterior tube 45 has a tapered end 49, and the interior tube 44 has a straight end 57 mounted flush with the end of exterior tube 45. FIG. 18 illustrates an embodiment where the downstream end 48 of the exterior tube 45 has a tapered end 49, and the interior tube 44 has a tapered end 59 mounted flush with the end of the exterior tube 45. FIG. 19 illustrates an embodiment where the downstream end 48 of the exterior tube 45 has a straight end 55, and the interior tube 44 has a tapered end 59 mounted flush with the end of the exterior tube 45. Although the tapered end 49 and tapered end 59 are shown as a straight taper, other types of tapers may be used without departing from the spirit and scope of the invention as described and claimed herein.

The various embodiments of the downstream end portion 17 of the fuel tubes 13 (Shown in FIG. 2) and the downstream end portion 48 of the coaxial tube assemblies 42 (shown in FIG. 13) serve to minimize flame holding/flashback problems. The premixer 10 will typically use one or more fuel tubes 13 within air tubes 15 to create multiple co-flow jets of air and fuel to prevent flame holding at the fuel injection location. The coaxial tube assemblies 42 provide fuel in combination with a sheath of annular diluent fluid such as N₂ to premix the air and fuel within the air tubes 15. The mixing lengths can be improved (shortened) by providing fuel tubes 13 or coaxial tube assemblies 42 with an enhanced turbulence capability such as, for example, through the use of chevron outlets such as V-shaped notch 33 (illustrated in FIG. 5) or U-shaped notch 38 (illustrated in FIG. 11). The enhanced turbulence capability provides fast mixing within short length in the air tubes 15.

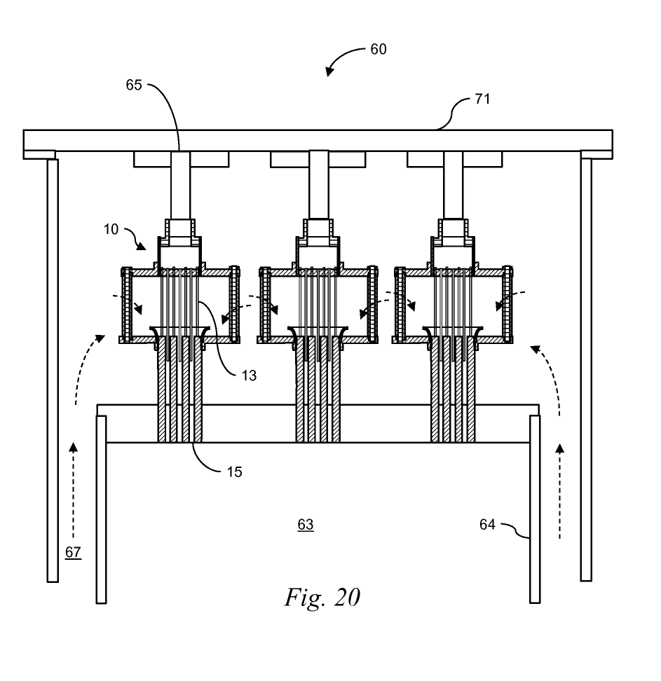

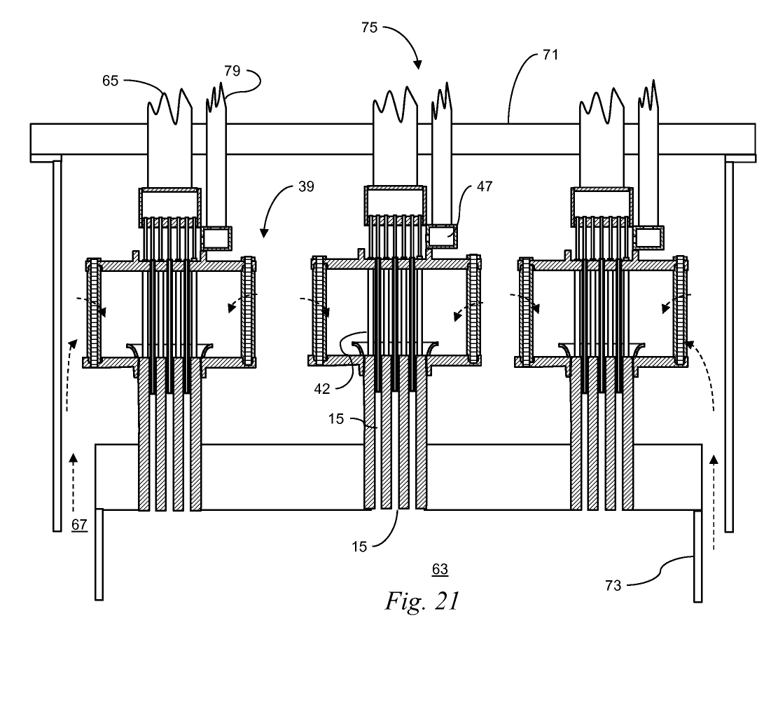

Illustrated in FIG. 20 is a combustor 60 having a plurality of premixers 10 that inject a fuel/air mixture into a combustion chamber 63 with a combustor liner 64. Each of the premixers 10 may be coupled to a fuel source 65. Air (shown by dashed arrows) from air source 67 enters the air tubes 15 and mixes with fuel injected through the fuel tubes 13 before entering the combustion chamber 63. The premixers 10 may be supported by a housing 71.

Illustrated in FIG. 21 is a combustor 75 having a liner 73. The combustor 75 includes a plurality of premixers 39. The premixers 39 may be coupled to one or more fuel sources 65 and at least one source of diluent fluid 79. Fuel and diluent fluid are conveyed through coaxial tube assemblies 42. Air (shown by dashed arrows) from air source 67 enters the air tubes 15 and mixes with fuel and diluent fluids injected through the coaxial tube assemblies 42 before entering the combustion chamber 63.

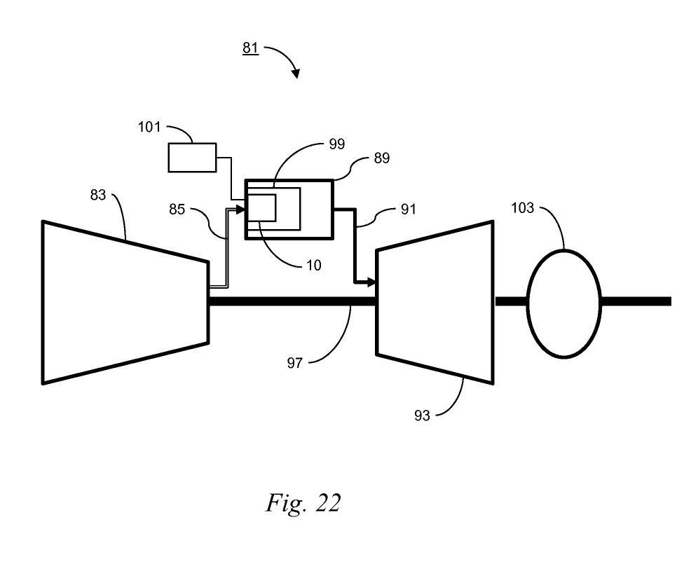

FIG. 22 is a schematic illustrating the environment in which the premixer 10 may be implemented. A gas turbine 81 may include a compressor 83 coupled to a compressed air conduit 85. The compressed air conduit 85 supplies compressed air to a combustor 89 coupled to an exhaust conduit 91. Exhaust from exhaust conduit 91 drives a turbine 93 which may drive a shaft 97 providing power to a load 103. The combustor 89 may include a nozzle assembly 99 with a premixer 10 (such as illustrated in FIG. 2) coupled to a fuel source 101. The premixer 10 may be used to provide multiple co-flow jets of air and fuel. The assemblies may be used for high H₂ combustion to improve the mixing of the high H₂ fuel and air without the cost of system pressure drop, and to provide reduced NOx and flashback probability.

The terminology used herein is for the purpose of describing particular embodiments only and is not intended to be limiting of the invention. Where the definition of terms departs from the commonly used meaning of the term, applicants intend to utilize the definitions provided herein, unless specifically indicated. The singular forms “a”, “an” and “the” are intended to include the plural forms as well, unless the context clearly indicates otherwise. It will be understood that, although the terms first, second, etc. may be used to describe various elements, these elements should not be limited by these terms. These terms are only used to distinguish one element from another. The term “and/or” includes any, and all, combinations of one or more of the associated listed items. The phrases “coupled to” and “coupled with” contemplates direct or indirect coupling.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements.

What is claimed:

1. A premixer, comprising:
a fuel plenum;
a burner tube;
an air tube formed in the burner tube;
a fuel tube having a chevron outlet, the fuel tube coupled to the fuel plenum, and disposed coaxially inside the air tube; and
an air source coupled to the air tube.

2. The premixer of claim 1, further comprising a bell mouth disposed at least partially about the burner tube and coupled to the air source, the bell mouth adapted to direct air into the air tube.

3. The premixer of claim 1, wherein the chevron outlet comprises a notch at a downstream end of the fuel tube.

4. The premixer of claim 3 wherein the notch comprises a notch selected from among a group consisting of a V shaped notch, a U shaped notch and a straight notch.

5. The premixer of claim 1, wherein the fuel tube comprises a tube with a tapered downstream end and a notch on the tapered downstream end.

6. The premixer of claim 1 wherein the air tube has a tapered upstream end.

7. The premixer of claim 1 wherein the fuel plenum is coupled to a fuel source.

8. A combustor, comprising:
a fuel source;
an air source; and
a plurality of premixers each of the plurality of premixers comprising:
a burner tube;
an air tube formed in the burner tube and coupled to the air source;
a fuel tube with a turbulence enhancing chevron outlet disposed inside the air tube and coupled to the fuel source; and
a bell mouth disposed at least partially about the burner tube and coupled to the air source the bell mouth adapted to direct air into the air tube.

9. The combustor of claim 8, wherein the turbulence enhancing chevron outlet comprises a notch at a downstream end of the fuel tube.

10. The combustor of claim 9 wherein the notch comprises a notch selected from among a group consisting of a V shaped notch, a U shaped notch and a straight notch.

11. The combustor of claim 8 wherein the fuel tube comprises a tube with a tapered downstream end and a notch on the tapered downstream end.

12. The combustor of claim 11 wherein the notch comprises a notch selected from among a group consisting of a V shaped notch, a U shaped notch and a straight notch.

13. The combustor of claim 8 wherein the air tube has a tapered upstream end.

14. A method of operating a premixer, comprising:
flowing fuel through a tube having a turbulence enhancing chevron outlet to provide a turbulent fuel flow;
providing an airflow into an air tube; and
injecting the turbulent fuel flow into the air tube.

15. The method of claim 14, wherein flowing fuel through a tube comprises flowing fuel through a tube having a tapered downstream end.

16. The method of claim 14 wherein flowing fuel though a tube comprises flowing fuel through a tube having a notch at a downstream end.

17. The method of claim 16 wherein flowing fuel through a tube having a notch at the downstream end comprises flowing fuel through a tube having a U-shaped notch at the downstream end.

18. The method of claim 16 wherein flowing fuel through a tube having a notch at the downstream end comprises flowing fuel through a tube having a V-shaped notch at the downstream end.

19. The method of claim 16 wherein flowing fuel through a tube having a notch at the downstream end comprises flowing fuel through a tube having a straight notch at the downstream end.

20. The method of claim 14 wherein providing an airflow into an air tube comprises providing an airflow into an air tube having a tapered upstream end.
